(19) United States
(12) Patent Application Publication
(10) Pub. No.: US 2008/0295281 A1
(43) Pub. Date: Dec. 4, 2008

(54) Cleaning device for surgical instruments and method of use

(76) Inventor: Jay S. Kumaran, Fort Wayne, IN (US)

Correspondence Address: LAW OFFICES OF BRIAN C. PAULS, 919 SOUTH HARRISON STREET, SUITE 320, FORT WAYNE, IN, 46802, US

(21) Appl. No.: 11/810,080

(22) Filed: Jun. 2, 2007

(51) Int. Cl. B08B 5/04; B08B 7/04

(52) U.S. Cl. 15/398

(57) ABSTRACT

A cleaning device for surgical instruments including a body and an abrasive cleaning surface. The body defines a mounting interface, an instrument opening, and an interior volume. The mounting interface is engaged with a vacuum source, such as a surgical evacuator, to place the interior volume in fluid communication with the vacuum source. The abrasive cleaning surface is disposed within the interior volume proximate the instrument opening whereby the surgical instruments can be inserted through the instrument opening to engage the abrasive surface and thereby clean the instruments. In some embodiments, the cleaning device is placed in an outer sealed package to maintain the sterilized condition of the device which may be discarded after a single use to thereby provide a convenient pre-sterilized and disposable cleaning device. A method of cleaning a surgical instrument is also disclosed.

### BACKGROUND OF THE INVENTION

1. Field of the Invention

The present invention relates to cleaning devices for surgical instruments and, more particularly, to cleaning devices suitable for use with electrosurgical instruments.

2. Description of the Related Art

A variety of electrosurgical units are well-known in the art and are often used in both human and veterinarian surgical procedures. Electrosurgical units typically include an electrosurgical tip, such as a laser knife or electrocautery tip, that are used to cut, cauterize or otherwise affect the tissue of patient. During an electrosurgical procedure using such a tip, it is not uncommon for tissue from the patient to adhere to and accumulate on the tip. When such a buildup takes place, the surgeon will typically clean the tip by rubbing the tip against an abrasive cleaning surface or scraping edge to remove the adhered tissue from the tip. A variety of cleaning devices have been developed for use with electrosurgical tips to provide such abrasive and scraping surfaces. There remains a need, however, for an improved and inexpensive cleaning device that can be used to effectively and conveniently clean electrosurgical tips during a surgical procedure.

### SUMMARY OF THE INVENTION

The present invention provides an improved cleaning device for use with surgical instruments that is detachably mountable on a surgical evacuator whereby debris removed from the surgical instrument is conveniently collected by the surgical evacuator.

The invention comprises, in one form thereof, a cleaning device for surgical instruments which is adapted for use with a vacuum source. The cleaning device includes a sterilizable device body and a sterilizable abrasive cleaning surface. The body defines a mounting interface, an instrument opening, and an interior volume. The mounting interface is sealingly engageable with the vacuum source and the sealing engagement of the mounting interface with the vacuum source places the interior volume in fluid communication with the vacuum source. The instrument opening is in fluid communication with the interior volume and is adapted to allow the partial insertion of the surgical instruments through the instrument opening into the interior volume. The abrasive cleaning surface is fixedly disposed within the interior volume and located proximate the instrument opening whereby the abrasive cleaning surface is engageable by the surgical instruments and thereby clean the surgical instruments.

In some embodiments, the cleaning device has an exterior surface that is substantially non-abrasive and the interior volume of the cleaning device defines an unobstructed passageway between the mounting interface and the instrument opening to thereby communicate a vacuum between the mounting interface and the instrument opening.

In other embodiments, the cleaning device is placed in an outer sealed package to maintain the sterilized condition of the device. Such a device may be discarded after a single use to thereby provide a convenient pre-sterilized and disposable cleaning device.

The invention comprises, in another form thereof, a method of cleaning a surgical instrument. The method includes providing a sterilized cleaning device which includes a body having an interior volume and an abrasive cleaning surface disposed within the interior volume; mounting the cleaning device on a surgical evacuator wherein the interior volume is at a pressure less than the surrounding atmospheric pressure when the evacuator is actuated; performing a surgical procedure with a surgical instrument; and cleaning the surgical instrument by inserting a portion of the instrument into the device body and engaging the instrument with the abrasive cleaning surface to thereby remove debris from the instrument and communicate the debris to the surgical evacuator through the interior volume of the cleaning device.

An advantage of the present invention is that by providing a cleaning device for a surgical instrument that can be mounted on a surgical evacuator, or other vacuum source, the debris removed from the surgical instrument during the cleaning process is easily captured by the evacuator.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a surgical table, a surgical laser, an evacuator and a cleaning device.

FIG. 2 is a perspective view of a portion of an evacuator nozzle and cleaning device.

FIG. 3 is an end view of the cleaning device of FIG. 2.

FIG. 4 is a cross sectional view taken along line 4-4 of FIG. 3.

FIG. 5 is a side view of the cleaning device sealed within an outer package.

FIG. 6 is a perspective view of a portion of an evacuator nozzle and an alternative embodiment of the cleaning device.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

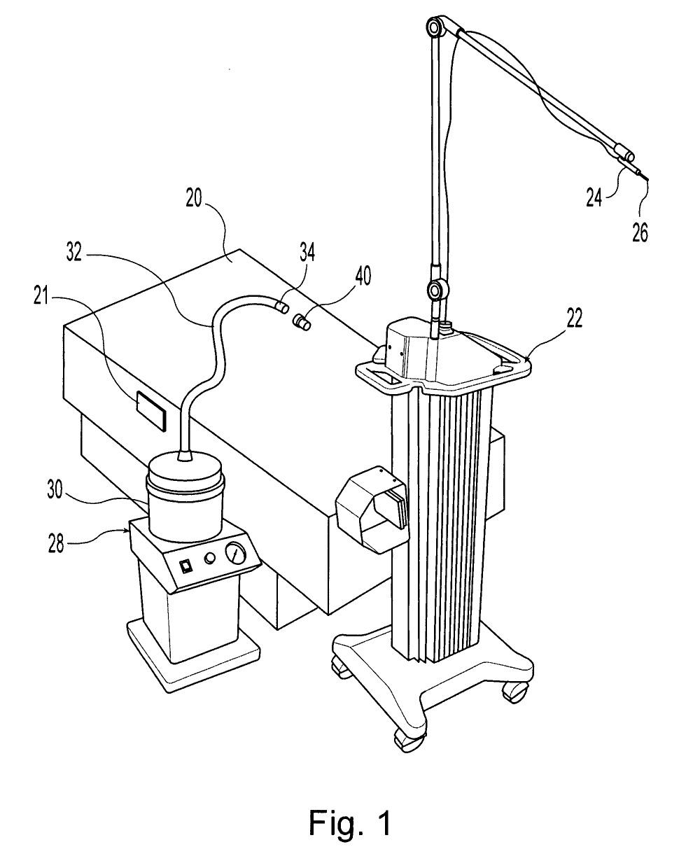

FIG. 1 schematically depicts several key components of an operating theatre suitable for use when performing veterinary surgical procedures on an animal such as a dog or a cat. Shown in FIG. 1 is an operating table 20 on which the patient (as used herein, the term “patient” may refer to both humans and non-human animals) is situated during the surgical procedure. An electrosurgical unit 22 is also shown in FIG. 1. Electrosurgical unit 22 is a conventional device and includes an electrosurgical instrument 24, such as an electrosurgical scalpel, having an electrosurgical tip 26 which may directly engage the tissue of the patient.

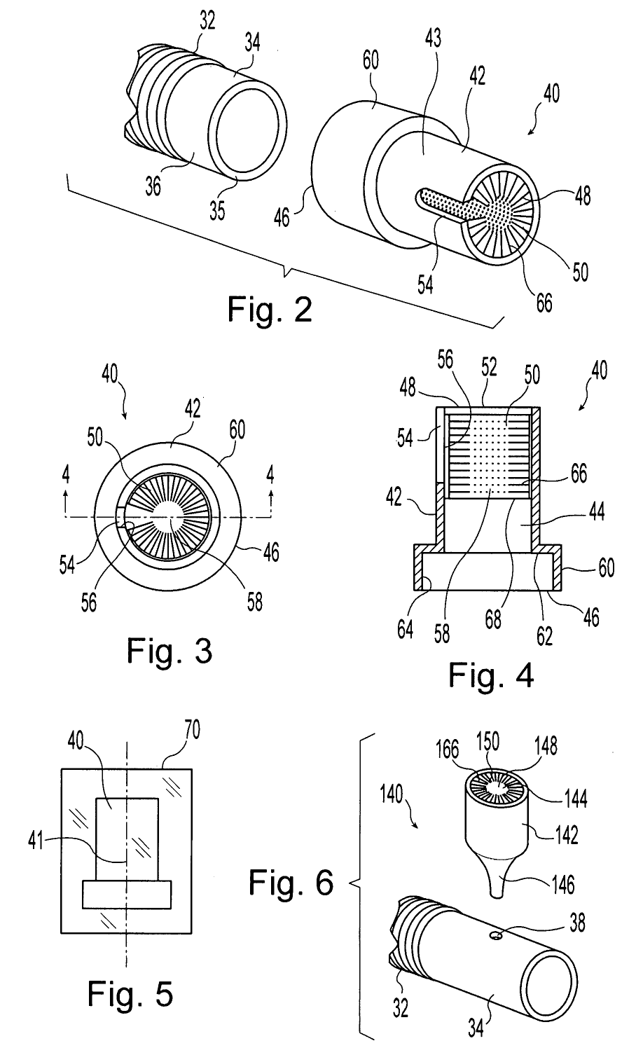

An evacuator 28 is also shown in FIG. 1 and includes a filter canister 30, a vacuum hose 32 and nozzle 34. Evacuator 28 is used to generate a vacuum that is used collect smoke that is generated by the operation of electrosurgical tip 26 on the tissue of the patient. Evacuators may also be used to evacuate liquids and other non-gaseous materials from the surgical site during a surgical procedure. A cleaning device 40 that is detachably mountable on evacuator nozzle 34 is also shown in FIG. 1. Cleaning device 40 is used to clean electrosurgical tip 26 during a surgical procedure and is shown in greater detail in FIGS. 2-5.

As best seen in FIGS. 2-5, cleaning device 40 includes a device body 42 which defines an interior volume 44 that extends between mounting interface 46 and instrument opening 48. An abrasive cleaning surface 50 is located within interior volume 44 for cleaning electrosurgical tip 26.

Cleaning device 40, including device body 42 and abrasive surface 50 is sterilized after device 40 has been manufactured so that it may be used in a surgical procedure. Cleaning device 40 is advantageously sealed within an outer package 52 as shown in FIG. 5 after manufacture and sterilization to maintain cleaning device 40 in a sterilized condition until immediately prior to the surgical procedure during which cleaning device 40 will be used. Although it may be possible to re-sterilize cleaning device 40 after it has been used to clean an electrosurgical tip 26 during a surgical procedure and thereby use cleaning device 40 in multiple surgical procedures, cleaning device 40 is relatively inexpensive and thereby provides a disposable cleaning device that can be discarded after a single use.

Abrasive cleaning surface 50 is fixed within interior volume 44 near instrument opening 48 so that it may be easily engaged by a surgical instrument that is inserted through opening 48. In addition to abrasive cleaning surface 50, cleaning device 40 provides scraping surfaces that are formed by rigid edges on device body 42. One such scraping edge is formed by the inner circular edge 52 of instrument opening 48. Many electrosurgical tips 26 have circular cross sections for which arcuate edge 52 is well-adapted to provide a scraping edge. Some electrosurgical tips 26, however, have a relatively flattened configuration which is more easily scraped clean along a rigid linear edge. Axially extending slot 54 in device body 52 forms an extension of instrument opening 48 and includes opposing linear edges 56 that provide such a rigid linear scraping edge.

Mounting interface 46 is formed on the axial end of body 42 that is opposite the end which defines instrument opening 48. In the embodiment illustrated in FIGS. 1-5, device body 42 and interior volume 44 are each substantially cylindrical in shape are concentric about a common axis 41. In this particular embodiment, mounting interface 46 is formed by enlarged diameter portion 60 that defines a substantially cylindrical socket with a stop surface 62 and a radially inward facing surface 64. When mounting cleaning device 40 on evacuator nozzle 34, nozzle 34 is inserted into socket 60 until the end surface 35 of nozzle 34 engages stop surface 62. Cleaning device 40 is dimensioned so that radially inward facing surface 64 engages the outer radial surface 36 of nozzle 34.

The engagement of end surface 35 with stop surface 62 and of inward facing surface 64 with outer surface 36 provides a sealing engagement between socket 60 and nozzle 34 that is substantially airtight and places interior volume 44 in fluid communication with vacuum hose 32 through nozzle 34. It is not essential that the engagement between mounting interface 46 (which is defined by socket 60 in the embodiment of FIGS. 1-5) and evacuator nozzle 34 (or other vacuum source) be perfectly airtight, the engagement merely needs to be sufficiently sealed to allow a vacuum to be communicated through interior volume 44 from mounting interface 46 to instrument opening 48.

In the embodiment illustrated in FIGS. 1-5, abrasive cleaning surface 50 includes a plurality of bristles 66. Bristles 66 are formed on and extend outwardly from a substantially planar layer of material 68 that is secured to the inner surface of body 42. As best seen in FIG. 3, bristles 66 extend circumferentially within interior volume 44 but do not fully radially circumscribe interior volume 44, leaving a small gap at slot 54. Bristles 66 extend radially inwardly toward axis 41 of body 42 but are not sufficiently long to meet at axis 41 and leave an unobstructed open passageway 58 that extends the full axial length of interior volume 44 from mounting interface 46 to instrument opening 48. Although a vacuum would still be communicated from mounting interface 46 to instrument opening 48 if bristles 66 did not leave an unobstructed passageway 58 in the center of interior volume 44, the provision of an unobstructed passageway facilitates a relatively high velocity intake of air, and entrained smoke, through instrument opening 48 during the surgical procedure. This allows cleaning device 40 to also act as an extension of evacuator nozzle 34 when it is not be used to clean electrosurgical tip 26. An unobstructed passageway 58 positioned adjacent abrasive surface 50 also facilitates the evacuation of debris, such as charred tissue, by evacuator 28 through vacuum hose 32 when the charred tissue is dislodged from electrosurgical tip 26 when tip 26 is rubbed against abrasive surface 50.

Although cleaning device 40 has a substantially cylindrical body 42 with a socket 60, other shapes and configurations of cleaning devices may also be used. For example, an alternative cleaning device 140 is illustrated in FIG. 6. Cleaning device 140 includes a mounting interface that is formed by a substantially frustum-shaped portion 146. (It is noted that frustrum-shaped portion defines slightly arcuate sidewalls which differ from a true frustrum.) Frustum-shaped portion 146 is inserted into an opening 38 that is formed in the sidewall of an evacuator nozzle 34. The press fit engagement of frustum-shaped portion 146 and opening 38 provides the sealing engagement between cleaning device 140 and evacuator nozzle 34.

Similar to cleaning device 40, cleaning device 140 includes a device body 142 that defines an interior volume 144 that extends between an opening at mounting interface 146 and an instrument opening 148. Abrasive surface 150 is positioned within interior volume 144 and positioned proximate instrument opening 148. Device body 140, however, does not include a longitudinal slot and the bristles 166 forming abrasive surface 150 fully circumscribe interior volume 144. Instrument opening 148 is in fluid communication with vacuum source 28 through interior volume 144 and allows insertion of electrosurgical tip 26 for cleaning engagement with abrasive surface 150.

There are a variety of commonly used electrosurgical tips 26. The materials used to form such electrosurgical tips 26 varies, with some tips being made of out of relatively hard materials such as ceramic materials and other tips being formed out of less hard materials such as steel. Due to this variation of hardness in electrosurgical tips 26, it is advantageous to provide cleaning devices 40, 140 with a variety of different abrasive surfaces 50 which may also have different hardness values. For example, the illustrated cleaning device 40 includes an abrasive surface 50 that is formed out of polymeric bristles 66 that are suitable for cleaning electrosurgical tips 26 formed out of a steel material. Illustrated cleaning device 140 includes an abrasive surface 150 that is formed out of stainless steel bristles 166 that are suitable for cleaning relatively hard electrosurgical tips such as ceramic-based tips.

Abrasive cleaning surfaces which do not rely upon bristles may also be used with cleaning devices in accordance with the present invention. For example, FIG. 1 illustrates a sandpaper pad 21 adhered to the side of operating table 20. The use of such a sandpaper pad 21 standing alone or adhered to an operating table 20 as shown in FIG. 1 to clean electrosurgical tips is known in the art. Instead of using bristles to form an abrasive surface, cleaning devices 40, 140 could alternatively use other abrasive surfaces such as a substantially planar member having a granular abrasive material secured to an outwardly facing surface, e.g., sandpaper or similar abrasive products. For example, with reference to FIGS. 3 and 4, a sheet of sand paper or similar product having a granular abrasive material could be attached to device body 42 in the same location as backing member 68 to thereby form an alternative cleaning device having a granular abrasive material forming the abrasive cleaning surface 50 instead of bristles 66.

Device bodies 42, 142 may be formed by any suitable manufacturing method, e.g., injection molding a polymeric material. When the abrasive cleaning surface within the interior volume of the cleaning device is formed by a plurality of bristles, e.g., bristles 66, 166, extending outwardly from a backing layer, the bristles may be secured in place within the interior volume of the cleaning device by various methods well known in the art. For example, an adhesive could be used to secure the backing layer to the device body, or, if both the backing layer and the device body are made of a polymeric material, ultrasonic welding could be used. When the bristles and backing layer are formed out of a metal material, e.g., stainless steel, stresses within the backing layer caused by bending the backing layer to fit within the device body may provide a radially-outward directed biasing force that secures the backing member in place within the device body. The device body may also include a recess in its interior volume for seating the backing layer in a desired position. Other suitable materials and manufacturing methods may also be employed with cleaning devices in accordance with the present invention.

In the illustrated cleaning devices 40, 140, the abrasive cleaning surface 50, 150 is located within the interior volume 44, 144 of the device body 42, 142 and cleaning devices 40, 140 each have an exterior surface that is substantially non-abrasive. By locating abrasive cleaning surfaces 50, 150 within interior volumes 44, 144, the debris removed from surgical instruments inserted into interior volumes 44, 144 is more easily collected by evacuator 28. Providing an abrasive cleaning surface on the exterior surface of cleaning devices 40, 140 would not be as conducive to the collection of such debris. Additionally, by providing cleaning device 40 with a non-abrasive exterior surface 43, exterior surface 43 is less likely to collect debris that might contaminate an incision or other surgical site on the patient and thereby facilitates the use of cleaning device 40 as an evacuator nozzle when it is not be used as a cleaning device during a surgical procedure.

When performing a surgical procedure using a cleaning device 40, 140, the pre-sterilized device 40, 140 would first be removed from its packaging 70 and mounted on the evacuator 28. The surgical procedure would then take place in its customary fashion. If cleaning device 40 is being used, device 40 would be used during the surgical procedure as the evacuator nozzle with smoke being evacuated through instrument opening 48 in the same manner as if cleaning device 40 were evacuator nozzle 34. When it becomes necessary during the procedure to clean electrosurgical tip 26, tip 26 would be inserted through instrument opening 48 to engage abrasive surface 50 and thereby clean tip 26 with the removed debris being evacuated through interior volume 44, the opening of mounting interface 46 and into evacuator 28. The surgical procedure would then resume with a cleaned electrosurgical tip 26.

When cleaning device 140 is used, nozzle 34 is used as an evacuator in its normal fashion during the surgical procedure. Although opening 38 diminishes the strength of the vacuum at the opening of nozzle 34, it is relatively minor and should not prevent the proper functioning of evacuator 28 and nozzle 34 during the surgical procedure. If desired, however, cleaning device 140 can be provided with a removable or hinged cap that is displaced when cleaning an instrument in device 140 and replaced to substantially prevent the entry of air through device 140 and opening 38 during use of nozzle 34 as a normal evacuator. When cleaning electrosurgical tip 26 with cleaning device 140, it is desirable to place a sterile object, e.g. a portion of the surgical drape, over the end of nozzle 34 so that substantially all of the air entering nozzle 34 enters through cleaning device 140 and opening 38 and thereby facilitates the evacuation of debris removed from electrosurgical tip 26. A pre-sterilized cap or similar object could be provided in the package used to contain cleaning device 140 prior to use for this purpose.

The illustrated examples 40, 140 are both shown being used with an evacuator 28 intended for use with smoke and airborne debris rather than liquids. Cleaning devices in accordance with the present invention, however, may also be used with evacuators used to evacuate liquids from a surgical site on a patient. For example, cleaning device 140 would be well suited for use with a liquid evacuator since the liquid could be evacuated through the evacuator nozzle without passing through cleaning device 140.

While this invention has been described as having an exemplary design, the present invention may be further modified within the spirit and scope of this disclosure. This application is therefore intended to cover any variations, uses, or adaptations of the invention using its general principles.

What is claimed is:

1. A cleaning device for surgical instruments which is adapted for use with a vacuum source, said cleaning device comprising:
a sterilizable device body said body defining a mounting interface, an instrument opening, and an interior volume; said mounting interface being sealingly engageable with the vacuum source wherein sealing engagement of said mounting interface with the vacuum source places said interior volume in fluid communication with the vacuum source, said instrument opening being in fluid communication with the interior volume and adapted to allow at least partial insertion of the surgical instruments through said instrument opening into said interior volume;
a sterilizable abrasive cleaning surface fixedly disposed within said interior volume and located proximate said instrument opening whereby said abrasive cleaning surface is engageable by the surgical instruments;
said interior volume defining an unobstructed passageway extending between said mounting interface and said instrument opening for communicating a vacuum therethrough; and
wherein said cleaning device has a substantially non-abrasive exterior surface.

2. The cleaning device of claim 1 wherein said abrasive cleaning surface comprises a plurality of bristles.

3. The cleaning device of claim 1 wherein said instrument opening defines a rigid edge adapted for scraping engagement with the surgical instruments.

4. The cleaning device of claim 1 wherein said device body and said interior volume each have a substantially cylindrical shape, said mounting interface and said instrument opening being disposed at opposing axial ends of said interior volume.

5. The cleaning device of claim 4 wherein said mounting interface comprises a substantially cylindrical socket for detachably mounting said device body on a cylindrical nozzle.

6. The cleaning device of claim 1 wherein said device body includes a generally frustum-shaped portion defining said mounting interface, said frustum-shaped portion being insertable into an opening to thereby detachably mount said device body on a vacuum source.

7. A pre-sterilized cleaning device for surgical instruments which is adapted for use with a vacuum source, said device comprising:
a sterilized device body said body defining a mounting interface, an instrument opening, and an interior volume; said mounting interface being sealingly engageable with the vacuum source wherein sealing engagement of said mounting interface with the vacuum source places said interior volume in fluid communication with the vacuum source, said instrument opening being in fluid communication with the interior volume and adapted to allow at least partial insertion of the surgical instruments through said instrument opening into said interior volume;
a sterilized abrasive cleaning surface disposed within said interior volume and located proximate said instrument opening whereby said abrasive cleaning surface is engageable by the surgical instrument; and
an outer sealed package, said sterilized device body disposed within said package, said package maintaining said device body in a sterilized condition prior to use of said cleaning device.

8. The cleaning device of claim 7 wherein said abrasive cleaning surface comprises a plurality of bristles.

9. The cleaning device of claim 8 wherein said interior volume defines an unobstructed passageway extending between said mounting interface and said instrument opening for communicating a vacuum therethrough and wherein said cleaning device has a substantially non-abrasive exterior surface.

10. The cleaning device of claim 8 wherein said bristles comprise stainless steel bristles.

11. The cleaning device of claim 8 wherein said bristles comprise polymeric bristles.

12. The cleaning device of claim 7 wherein said abrasive cleaning surface comprises a granular abrasive material.

13. The cleaning device of claim 7 wherein said instrument opening defines a rigid edge adapted for scraping engagement with the surgical instruments.

14. The cleaning device of claim 7 wherein said device body and said interior volume each have a substantially cylindrical shape, said mounting interface and said instrument opening being disposed at opposing axial ends of said interior volume.

15. The cleaning device of claim 14 wherein said instrument opening is defined by a substantially circular opening on a first end of said device body and an axially extending slot, said device body comprising a rigid linear edge defining at least a portion of said slot whereby said rigid linear edge forms a scraping surface for surgical instruments.

16. The cleaning device of claim 14 wherein said mounting interface comprises a substantially cylindrical socket for detachably mounting said device body on a cylindrical nozzle.

17. The cleaning device of claim 7 wherein said device body includes a generally frustum-shaped portion defining said mounting interface, said frustum-shaped portion being insertable into an opening to thereby detachably mount said device body on a vacuum source.

18. A method of cleaning a surgical instrument, said method comprising:
providing a sterilized cleaning device, the device including a body having an interior volume and an abrasive cleaning surface disposed within the interior volume;
mounting the cleaning device on a surgical evacuator wherein the interior volume is at a pressure less than the surrounding atmospheric pressure when the evacuator is actuated;
performing a surgical procedure with a surgical instrument;
cleaning the surgical instrument by inserting a portion of the instrument into the device body and engaging the instrument with the abrasive cleaning surface and wherein debris removed from the instrument by engagement with the abrasive cleaning surface is communicated to the surgical evacuator through the interior volume of the cleaning device.

19. The method of claim 18 wherein the step of providing a sterilized cleaning device includes:
enclosing the sterilized cleaning device in a sealed package and opening the package immediately prior to performing the surgical procedure.

20. The method of claim 19 further comprising the step of discarding the cleaning device after using the device in a single surgical procedure.

21. The method of claim 20 wherein the surgical procedure is performed upon a non-human animal.

22. The method of claim 18 wherein the interior volume defines an unobstructed passageway between the surgical evacuator and an instrument opening through which the surgical instrument is inserted to engage the abrasive cleaning surface; and wherein said method further comprises:
evacuating smoke during the surgical procedure by positioning the instrument opening proximate the surgical instrument while the surgical procedure is being conducted with the surgical instrument and evacuating smoke through the instrument opening.

23. The method of claim 18 wherein the step of mounting the cleaning device on the surgical evacuator includes inserting a cylindrical nozzle of the evacuator into a socket on the cleaning device.

24. The method of claim 23 wherein the interior volume of the cleaning device extends from the socket to an instrument opening, the instrument opening including a portion defined by a substantially linear rigid edge; and wherein said method further comprises:
cleaning the surgical instrument by scraping the surgical instrument against the substantially linear rigid edge.
